(19) United States
(12) Patent Application Publication
(10) Pub. No.: US 2014/0091105 A1
(43) Pub. Date: Apr. 3, 2014

(54) BEVERAGE DISPENSING SYSTEM

(71) Applicants: A.A. Jud Schroeder, San Antonio, TX (US); Jody Jacobsen, Defiance, MO (US); Joseph P. Webster, San Antonio, TX (US)

(72) Inventors: A.A. Jud Schroeder, San Antonio, TX (US); Jody Jacobsen, Defiance, MO (US); Joseph P. Webster, San Antonio, TX (US)

(21) Appl. No.: 13/839,547

(22) Filed: Mar. 15, 2013

Related U.S. Application Data
(60) Provisional application No. 61/707,499, filed on Sep. 28, 2012.

(51) Int. Cl. B67D 7/74

(52) U.S. Cl. CPC B67D 1/0045
USPC 222/129.2

(57) ABSTRACT

Various systems, processes, and technique may be used to achieve beverage dispensing. In particular implementations, a beverage dispensing system may include a flow controller, a venturi-type mixer, and a dispensing faucet. The flow controller may be adapted to regulate water flow rate therethrough. The venturi-type mixer may be coupled to the flow controller and to a beverage concentrate syrup supply conduit. The mixer may be adapted to draw beverage concentrate syrup in response to water flowing through the mixer and begin mixing the beverage concentrate syrup with the water, the mixture of beverage concentrate syrup and water forming a beverage. The beverage dispensing faucet may be coupled to the mixer and adapted to receive the mixture and dispense the beverage.

### RELATED APPLICATIONS

This application claims priority from and the benefit of U.S. Provisional Patent Application No. 61/707,499, which is entitled “Beverage Dispensing System,” was filed on Sep. 28, 2012, and is herein incorporated by reference.

### BACKGROUND OF THE INVENTION

Food service establishments (e.g., restaurants) often make non-carbonated beverages (e.g., tea or fruit juice) by using dispensing systems that mix beverage concentrates, usually in the form of a syrup, with water. In common dispensing systems, a container of concentrated beverage (e.g., a bag) is coupled to a venturi-type mixer, to which water (e.g., from a public supply) is also conveyed through a pressure regulator. The pressure regulator reduces the pressure from the water source to prevent damaging components of the dispensing system. The output of the venturi mixer is coupled to a dispensing faucet. Opening the dispensing faucet allows the flow of water through the venturi mixer, which draws the beverage concentrate into the venturi mixer and mixes it with the water. The water/beverage concentrate mixture then travels to the dispensing faucet where it is dispensed. Thus, when the beverage leaves the dispensing faucet, it is ready for consumption.

### SUMMARY

Various systems, processes, and techniques for dispensing beverages are disclosed. In certain implementations, a beverage dispensing system may include a flow controller, a venturi-type mixer, and a beverage dispensing faucet. The flow controller may be adapted to regulate water flow rate therethrough. The venturi-type mixer may be coupled to the flow controller and to a beverage concentrate syrup supply conduit. The mixer may be adapted to draw beverage concentrate syrup in response to water flowing through the mixer and begin mixing the beverage concentrate syrup with the water, the mixture of beverage concentrate syrup and water forming a beverage. The beverage dispensing faucet may be coupled to the mixer and adapted to receive the mixture and dispense the beverage.

In certain implementations, the mixer may include a beverage concentrate syrup adjustment mechanism. Additionally, the system may include a water shut off coupled to the flow controller, and a water inlet coupled to the flow controller. The water inlet may be adapted to be connected to a public water supply.

In particular implementations, the system may include a housing that surrounds the flow controller and the mixer. The beverage dispensing faucet may be attached to the housing. The housing may include a compartment for storing a container of beverage concentrate syrup above the mixer.

Some implementations may include a second venturi-type mixer and a second beverage dispensing faucet. The second venturi-type mixer may also be coupled to the flow controller and to a second beverage concentrate syrup supply conduit. The second mixer may be adapted to draw the second beverage concentrate syrup in response to water flowing through the second mixer and begin mixing the second beverage concentrate syrup with the water, the mixture of the second beverage concentrate syrup and water forming a second beverage. The second beverage dispensing faucet may be coupled to the second mixer and adapted to dispense the second beverage.

In particular implementations, the flow controller may be adapted to allow a fluid pressure greater than 30 pounds per square inch (psi) downstream. Additionally, the dispensing faucet may be adapted to withstand fluid pressure greater than 30 psi.

In certain implementations, the flow controller may be adapted to allow a fluid pressure greater than 70 psi downstream. The dispensing faucet may be adapted to withstand fluid pressure greater than 70 psi.

In some implementations, the mixer is adapted to substantially mix the beverage concentrate syrup and the water. Additionally, the draw provided by the mixer may regulate how much beverage concentrate syrup is mixed with the water.

In particular implementations, the beverage dispensing faucet includes a handle and a nozzle. The activation of the handle may manually control how much fluid flows through the system.

Various implementations may include one or more features. For example, by using a flow regulator, a beverage dispensing system may provide a more consistent flow through a venturi mixer and achieve a better mixture error range (e.g., 4-5%), and possibly even approaching the optimal (i.e., 2.44%), without having to use a pump. Although the flow regulator may allow much higher pressures in the system (e.g., up to 140 psi), by proper design, the system may be able to handle the higher pressures. Using this arrangement eliminates the need for a pressure regulator in most cases, as water pressure available from public water supplies is normally much lower. Using a flow regulator also provides a higher flow rate, which provides better suction on the beverage concentrate syrup container and also allows for a faster dispensing rate. In certain implementations, a beverage dispensing system may have no internal electrical devices. This may provide enhanced safety as there is little chance of fluid coming into contact with electricity.

A variety of other features will be apparent to one skilled in the art from the following detailed description and claims, along with the accompanying drawings.

### BRIEF DESCRIPTION OF THE DRAWINGS

FIGS. 1A-B are perspective views of an example beverage dispensing system.

FIG. 2 is a line drawing illustrating a cross-section of an example venturi mixer.

FIG. 3 is a block diagram illustrating another example beverage dispensing system.

FIG. 4 is a block diagram illustrating an additional example beverage dispensing system.

### DETAILED DESCRIPTION

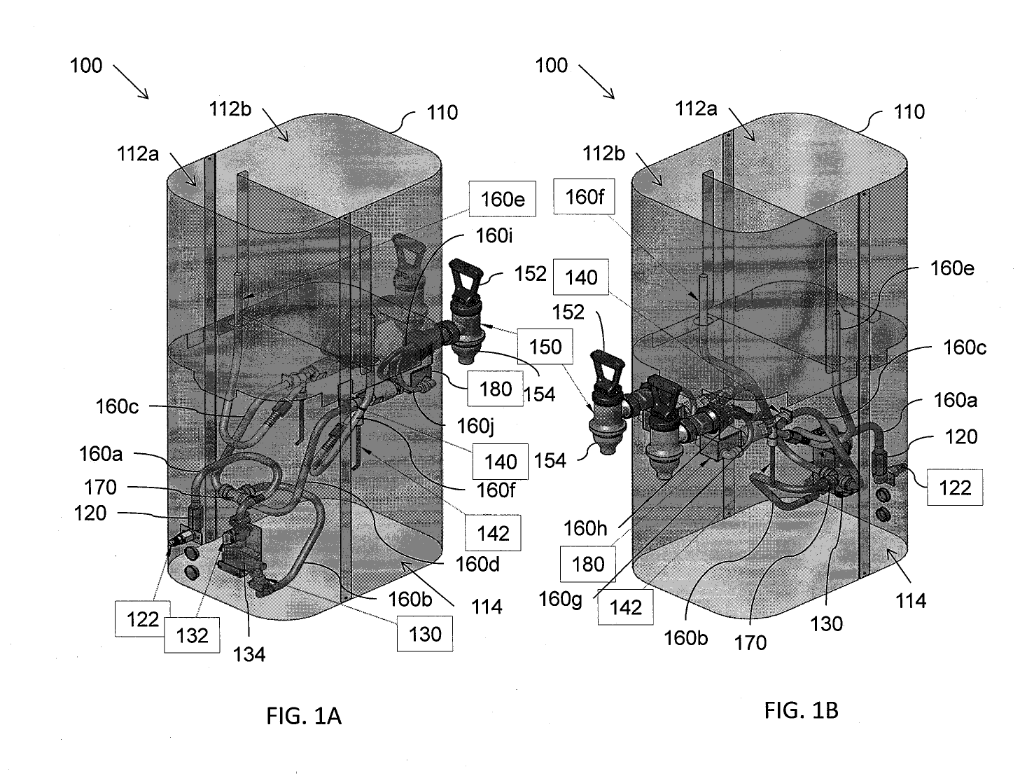

FIGS. 1A-1B illustrate an example beverage dispensing system 100. System 100 includes, among other things, a housing 110, a water inlet assembly 120, a flow controller assembly 130, two venturi-type mixers 140, and two dispensing faucets 150.

Housing 110 includes two beverage storage compartments 112 and a beverage mix compartment 114. Housing 110 may be made of metal, plastic, or any other appropriate material. In particular implementations, housing 110 is sized to sit on a counter.

Water inlet assembly 120 includes a connector 122 for coupling to a water source. The water source may be local to system 100 or remote (e.g., a public water supply). Water inlet assembly 120 may be adapted to receive water at a standard operating pressure (e.g., 30-130 psi). Water inlet assembly 120 may be made of brass, stainless steel, plastic, or any other appropriate material.

Water inlet assembly 120 is coupled to flow controller assembly 130 by a conduit 160a. Conduit 160a, along with other conduits 160 in system 100, may be a hose, tube, or any other appropriate device for conveying fluid. Conduits 160 may be made of metal, rubber, plastic, silicone-rubber, or any other appropriate material.

Flow controller assembly 130 includes a shut-off valve 132 and a flow controller 134. Shut-off valve 132 may, for example, be a ball valve, a butterfly valve, or any other device for controllably restricting fluid flow. Flow controller 134 regulates the flow rate of water through system 100 during dispensing operations. In particular implementations, flow controller 134 may regulate the flow rate to between about 0.5 ounces/s to 1.0 ounces/s. As part of regulating flow, flow controller 134 may maintain flow rate even as pressure changes. In certain implementations, flow controller 134 may operate exclusively by mechanical techniques. Thus, flow controller 134 may require no electricity. In particular implementations, flow controller 134 may be similar to the 639-0030/Valve Assy/Cntl, Soda 1 flow controller available from Schroeder America of San Antonio, Tex.

Flow controller 134 may be adapted to operate under relatively high pressures. Public water supplies typically have pressure between 30-80 psi, but some go up to 130 psi. Thus, flow controller 134 may be designed to work with pressures up to 80 psi and, in certain implementations, up to 130 psi. The 639-0030/Valve Assy/Cntl, Soda 1 flow controller available from Schroeder America, for example, is able to operate under those pressures.

Flow controller assembly 130 is coupled to venturi mixers 140 through a conduit 160b, a flow splitter 170, and conduits 160c-d. Flow splitter 170 splits the fluid flow from flow controller 134 so that both venturi mixers 140 are fed. Conduits 160c-d each take a portion of the split flow to a respective venturi mixer 140.

Venturi mixers 140 are water-driven venturi-type mixing devices that combine water with a beverage concentrate syrup, such as tea, coffee, fruit juice, or any other appropriate non-carbonated beverage, to yield a finished beverage. A beverage concentrate syrup typically has a viscosity substantially higher than that of water.

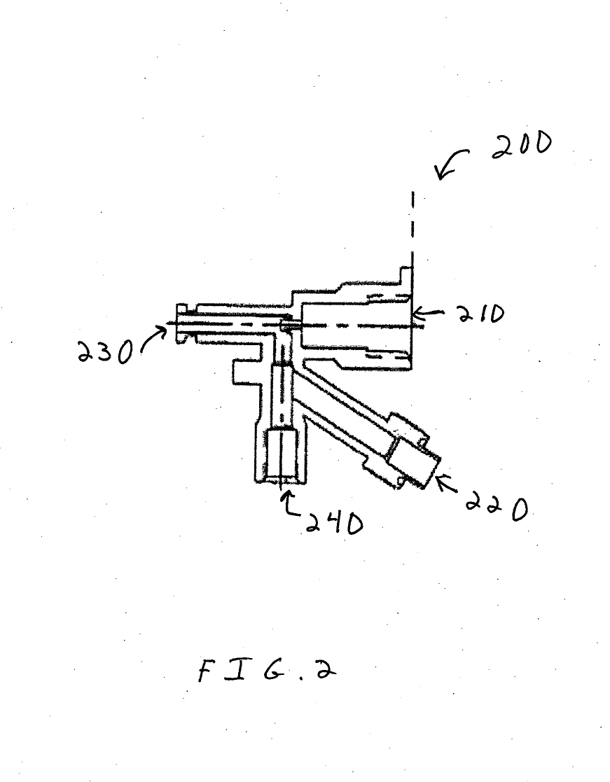

An example venturi mixer 200 is illustrated in FIG. 2. As illustrated, mixer 200 includes a water inlet port 210, a beverage concentrate syrup inlet port 220, and a beverage outlet port 230. Mixer 200 also includes a beverage adjustment port 240, in which an adjustment mechanism (e.g., a set screw) may be inserted and adjusted. Mixer 200 may, for example, be similar to the PN 6181 Mixing Head mixer available from Newco Enterprises, Inc. of St. Charles, Miss.

The beverage concentrate syrups (not shown) are respectively drawn to venturi mixers 140 through supply conduits 160e-f based on the water flowing through the respective venturi mixers 140. The beverage concentrate syrups are typically substantially mixed with the water when leaving the venturi mixers. Venturi mixers 140 include a mixture adjustment mechanism 142 for adjusting the amount of syrup flowing into the mixers, which thereby alters the mixture ratio of the dispensed beverage. Venturi mixers 140 may be made of metal, plastic, or any other appropriate material.

In this implementation, venturi mixers 140 are the primary devices controlling the flow of beverage concentrate syrup during beverage dispensing. That is, the draw provided by the water passing through the venturi mixers determines how much beverage concentrate syrup is mixed with the water. Thus, no pumps, solenoids, valves, or other fluid control devices are being used to directly control the amount of beverage concentrate syrup being drawn during beverage dispensing. Other fluid control devices may also be used in particular implementations, however.

Each venturi mixer 140 is coupled to a respective manifold 180, which provides an interface between venturi mixers 140 and dispensing faucets 150. Dispensing faucets 150 are coupled to manifolds 180 through conduits 160g-j, with a pair of these conduits going to a respective dispensing faucet 150. Each dispensing faucet 150 includes a handle 152 and a nozzle 154. Handle 152 is mechanically operated and serves as a lever to activate a valve (not viewable) inside the dispensing faucet. The valve may, for example, be a poppet valve or any other appropriate type of valve. If pressures are not too high, a pinch valve, for instance, could be used. A variety of other appropriate faucets are described in U.S. patent application Ser. No. 12/944,457, which is entitled “A Post-Mix Dispenser Assembly,” was filed on Nov. 11, 2010, and is herein incorporated by reference.

The activation of a handle 152 may allow fluid to flow in system 100. In certain implementations, dispensing faucets 150 may be the only thing that needs to be activated, once system 100 is setup, to allow fluid to flow in system 100. Thus, system 100 may be manually operated. That is, it may include no electronically-controlled fluid control mechanisms (e.g., pumps, solenoids, or valves) coupled to dispensing faucets 150.

Dispensing faucets 150 may be able to withstand relatively high pressures (e.g., above 30 psi), and in some implementations may be able to withstand pressures up to 140 psi, without leaking. In particular implementations, dispensing faucets 150 may be similar to the 637-0005, Assy, Valve, Post Mix dispensing faucets available from Schroeder America of San Antonio, Tex. Dispensing faucets 150 may be made from metal, plastic, or any other appropriate material.

In certain modes of operation, beverage containers (e.g., bags) are coupled to conduits 160e-f and placed in beverage compartments 112. The coupling between conduits 160e-f and the beverage container may, for example, be accomplished with a connector similar to the 15F011191H Bib Connector of the QCD 2 #400137 connector available from Liquid Box of Worthington, Ohio.

In certain implementations, a cover (e.g., a lid) may then be placed over beverage compartments 112. A water supply is then coupled to water inlet assembly 120, and shut-off valve 132 is opened. Dispensing faucets 150 are then opened by activating handles 152 (either one at a time or simultaneously) to allow water to flow therethrough. Flow controller 134 regulates the flow of water to a prescribed flow rate and supplies it to venturi mixers 140. The flow of the water through venturi mixers 140 draws the beverage concentrate syrup from the beverage containers. Note that the mix of the dispensed beverage may be inappropriate for the first few seconds of use until a steady state has been reached for the flows through venturi mixers 140.

In certain implementations, the dispensed beverage may be chilled. For example, chilled water could be fed through water inlet assembly 120 or a chilling unit could be placed inside housing 110. Since water is mixed with the beverage concentrate syrup in a ratio of between about 5:1 to 10:1, this should chill the dispensed beverage. In particular implementations, however, the concentrated beverage syrup may also be chilled (e.g., by pre-chilling before insertion in compartments 112 or refrigerating compartments 112).

System 100 has a variety of features. Previous beverage dispensing systems that utilize a venturi-type mixer are limited by the need of a pressure regulator to reduce the water pressure within the device (e.g., to less than 30 psi). Public water supplies (e.g., municipal or county) use pressures between 30 psi to 130 psi, and the reduced pressure is necessary to protect internal components as well as to ensure that the pressure remains below the cracking pressure of the dispensing faucet, thereby preventing leaks, although pressure may still creep above the regulator set point and result in dripping from the faucet. A pressure regulator typically produces inconsistent flows, however, and provides an error range in the mixture of between 7-8%, which is of marginal quality. The accompanying reduced flow rate of the lower pressure also increases dispensing times.

By using a flow regulator, however, system 100 may provide a more consistent flow through venturi mixers 140 and achieve a better mixture error range (e.g., 4-5%), and possibly even approaching the optimal (i.e., 2.44%), without having to use a pump. Although a flow regulator may allow much higher pressures in the system (e.g., up to 140 psi), by proper design, the system may be able to handle the higher pressures. Using this arrangement eliminates the need for a pressure regulator in most cases, as water pressure available from public water supplies is normally much lower. Using a flow regulator also provides a higher flow rate, which provides better suction on the concentrate syrup container and also allows for a faster dispensing rate.

In certain implementations, system 100 also has no electrical devices internal to housing 110. This may provide enhanced safety as there is little chance of fluid coming into contact with electricity.

Although FIG. 1 illustrates one example beverage dispensing system, other beverage dispensing systems may include fewer, additional, and/or a different arrangement of components. For example, a beverage dispensing system may include fewer or additional dispensing faucets. For instance, a beverage dispensing system may include one dispensing faucet. As another example, a dispensing faucet may have fewer or additional feed conduits from the venturi mixers. For instance, a faucet designed for post-mix may have only one feed conduit. As another example, a pre-mix faucet may be used. As an additional example, a beverage dispensing system may not include flow splitter 170 and/or manifolds 180. As a further example, a check valve may be included in one or more supply lines for the beverage concentrate syrup to prevent water from traveling to the beverage concentrate syrup containers. The check valve may have little, if any, effect on the flow of the beverage concentrate syrup, however.

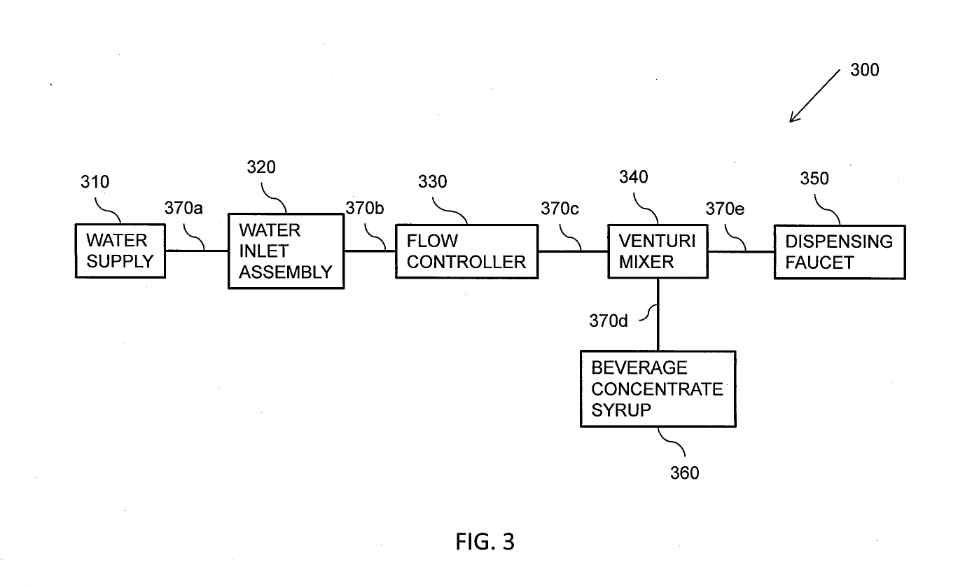

FIG. 3 illustrates another example beverage dispensing system 300. System 300 includes a water supply 310, a water inlet assembly 320, a flow controller 330, a venturi-type mixer 340, a dispensing faucet 350, and a beverage concentrate syrup 360, which are coupled together by conduits 370. Conduits 370 may, for example, be a hose, tube, or any other appropriate fluid conveyor and may be of metal, rubber, plastic, silicone-rubber, or any other appropriate material.

Water supply 310 may, for example, be local to system 300 or remote (e.g., a public water supply). Water supply 310 is coupled to water inlet assembly 320 by a conduit 370a.

Water inlet assembly 320 may be adapted to receive water at a standard operating pressure (e.g., 30-130 psi). Water inlet assembly 320 may be made of brass, stainless steel, plastic, or any other appropriate material. Water inlet assembly 320 is coupled to flow controller assembly 330 by conduit 370b.

Flow controller 330 regulates the flow rate of water through system 300. In particular implementations, flow controller 134 may regulate the flow rate to between 0.5 ounces/s to 1.0 ounces/s. As part of regulating flow, flow controller 330 may maintain flow rate even as pressure changes.

In certain implementations, flow controller 330 may be operate under relatively high pressures. Public water supplies typically have pressures between 30-80 psi, but some go up to 130 psi. Thus, flow controller 330 may be designed to work with pressures up to 80 psi and, in certain implementations, up to 130 psi. In particular implementations, flow controller 330 may be a similar to the 639-0030/Valve Assy/Cntl, Soda 1 flow controller available from Schroeder America of San Antonio, Tex.

Flow controller 330 is coupled to venturi mixer 340 through a conduit 370c. Venturi mixer 340 is a water-driven venturi-type mixing device that combines water with beverage concentrate syrup 360, which may, for example, be tea, coffee, fruit juice, or any other appropriate non-carbonated beverage, to yield a finished beverage. Beverage concentrate syrup 360 typically has a viscosity substantially higher than that of water.

Beverage concentrate syrup 360 is drawn into venturi mixer 340 through a conduit 370d based on the water flowing through the venturi mixer. The beverage concentrate syrup may, for example, be in a bag. The beverage concentrate syrup is typically substantially mixed with the water when leaving the venturi mixer. In certain implementations, venturi mixer 340 may include a mixture adjustment mechanism for adjusting the amount of beverage concentrate syrup flowing into the mixer, which thereby alters the mixture ratio of the dispensed beverage. Venturi mixer 340 may be made of metal, plastic, or any other appropriate material.

Venturi mixer 340 may be the primary device controlling the flow of beverage concentrate syrup during beverage dispensing. That is, the draw provided by the water passing through the venturi mixer determines how much beverage concentrate syrup is mixed with the water. Thus, no pumps, solenoids, valves, or other fluid control devices are being used to directly control the amount of beverage concentrate syrup being drawn during beverage dispensing. Other fluid control devices may also be used in particular implementations, however.

Venturi mixer 340 is coupled to dispensing faucet 350 by conduit 370f. In particular implementations, dispensing faucet 350 is typically able to withstand relatively high pressures (e.g., above 30 psi), and in some implementations may be able to withstand pressures up to 140 psi, without leaking. Dispensing faucet 340 may, for example, be similar to the 637-0005 Assy, Valve, Post Mix faucet available from Schroeder America of San Antonio, Tex. An appropriate pre-mix faucet may also be used. Dispensing faucet 340 may be made from metal, plastic, or any other appropriate material.

In certain modes of operation, beverage concentrate syrup 360 is coupled to conduit 370d to fluidly couple the syrup with venturi'mixer 340. Water supply 310 is also coupled to water inlet assembly 320. Dispensing faucet 350 is then opened to allow water to flow through system 300. As the water flows through flow controller 330, the flow rate is regulated to a prescribed flow rate. The flow of water through venturi mixer 340 draws beverage concentrate syrup 360 into the venturi mixer where the beverage concentrate syrup is mixed with the water. The mixture then flows to dispensing faucet 350, where the beverage is provided for consumption.

The mixture may achieve complete mixing in venturi mixer 340, in conduit 370e, in dispensing faucet 350, or in a container into which the mixture is dispensed. Regardless of where complete mixing occurs, the mixture that is provided to the container forms the beverage.

In certain implementations, the dispensed beverage may be chilled. For example, chilled water could be fed through water inlet assembly 320 or a chilling unit could be incorporated in the system (e.g., between water inlet assembly 320 and flow controller 330). Since the water is mixed with the beverage concentrate syrup in a ratio of between about 5:1 to 10:1, this should chill the dispensed beverage. In particular implementations, however, the beverage concentrate syrup may also be chilled (e.g., by pre-chilling before insertion or incorporating a chilling unit in the system).

System 300 has a variety of features. Previous beverage dispensing systems that utilize a venturi-type mixer are limited by the need of a pressure regulator to reduce the water pressure within the device (e.g., to less than 30 psi). Public water supplies typically use pressures between 30 psi to 130 psi, and the reduced pressure is necessary to protect internal components as well as to ensure that the pressure remains below the cracking pressure of the dispensing faucet, thereby preventing leaks, although pressure may still creep above the regulator set point and result in dripping from the faucet. A pressure regulator typically produces inconsistent flows, however, and provides an error range in the mixture of between 7-8%, which is of marginal quality. The accompanying reduced flow rate of the lower pressure also increases dispensing times.

By using a flow regulator, however, system 300 may provide a more consistent flow through venturi mixer 340 and achieve a better mixture error range (e.g., 4-5%), and possibly even approaching the optimal (i.e., 2.44%) without having to use a pump. In certain implementations, no electrical components are used. Although the flow regulator may allow much higher pressures in the system (e.g., up to 140 psi), by proper design, the system may be able to handle the higher pressures. Using this arrangement eliminates the need for a pressure regulator in most cases, as water pressure available from public water supplies is normally much lower. Using a flow regulator also provides a higher flow rate, which provides better suction on the concentrate container and also allows for a faster dispensing rate.

Although FIG. 3 illustrates one example beverage dispensing system, other beverage dispensing systems may include fewer, additional, and/or a different arrangement of components. For example, a beverage dispensing system may include additional dispensing faucets. For instance, a beverage dispensing system may include two or three dispensing faucets. As another example, a beverage dispensing system may include a housing. The housing may, for example, include a beverage storage compartment and a beverage mix compartment. Additionally, a water supply may not be part of system 300.

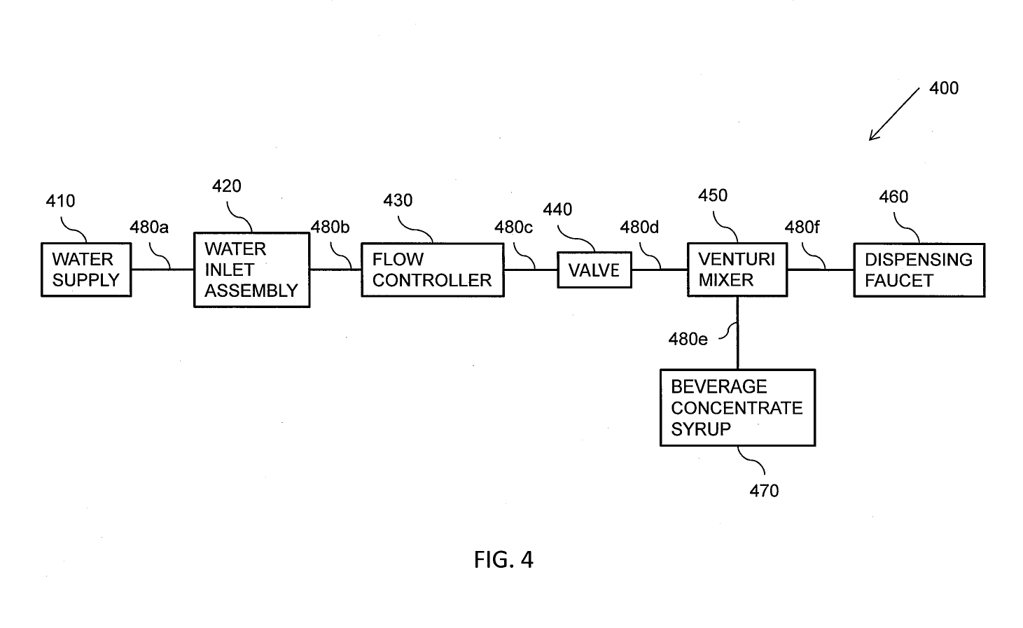

FIG. 4 illustrates another example beverage dispensing system 400. System 400 includes a water supply 410, a water inlet assembly 420, a flow controller 430, a venturi-type mixer 450, a dispensing faucet 460, and a beverage concentrate syrup 470, which may be similar to the components system 300. System 400 also includes conduits 480 to link the components together, which may also be similar to the conduits in system 300. Additionally, system 400 includes a valve 440.

Valve 440 is in the fluid path between flow controller 430 and venturi mixer 450 and functions to start and stop water flow through system 400. In particular implementations, valve 440 may be a solenoid-actuated valve. Valve 440 may, for example, be an SFCV solenoid valve available from Schroeder America, of San Antonio, Tex. Other type of valves may be used in other implementations.

Even with valve 440, flow controller 430 is still responsible for regulating the flow rate of water through the system. Thus, the water flow rate into venturi mixer 450 is still tightly controlled to draw beverage concentrate syrup 470 into the venturi mixer 450 with relatively small error ranges, the draw provided by the water passing through the venturi mixer determining how much beverage concentrate syrup is mixed with the water.

Dispensing faucet 460 may actuate valve 440. In certain implementations, a sensor in the dispensing faucet (e.g., a Hall effect sensor) may detect actuation of the faucet and generate a signal commanding valve 440 to open. Dispensing faucet 460 may, for example, simply dispense the beverage in these implementations, or it may also control beverage flow (e.g., by having a valve).

With valve 440, dispensing faucet 460 may not be required withstand high pressures even if water supply 410 has a high pressure (e.g., greater than 30 psi). Valve 440 may block the pressure when water is not running through system 400.

In certain modes of operation, beverage concentrate syrup 470 is coupled to conduit 480e to fluidly couple the syrup with venturi mixer 450. Water supply 410 is also coupled to water inlet assembly 420. Dispensing faucet 460 is then opened to dispense the beverage. The actuation of dispensing faucet 460 generates a signal for valve 440 to open, allowing water to flow through system 400. As the water flows through flow controller 430, the flow rate is regulated to a prescribed flow rate. The flow of water through venturi mixer 450 draws beverage concentrate syrup 470 into the venturi mixer where the beverage concentrate syrup is mixed with the water. The mixture then flows to dispensing faucet 460, where the beverage is provided for consumption.

The mixture may achieve complete mixing in venturi mixer 450, in conduit 480f, in dispensing faucet 460, or in a container into which the mixture is dispensed. Regardless of where complete mixing occurs, the mixture that is provided to the container forms the beverage.

In certain implementations, the dispensed beverage may be chilled. For example, chilled water could be fed through water inlet assembly 420 or a chilling unit could be incorporated in the system (e.g., between water inlet assembly 420 and flow controller 430). Since the water is mixed with the beverage concentrate syrup in a ratio of between about 5:1 to 10:1, this should chill the dispensed beverage. In particular implementations, however, the beverage concentrate syrup may also be chilled (e.g., by pre-chilling before insertion or incorporating a chilling unit in the system).

System 400 has a variety of features. Previous beverage dispensing systems that utilize a venturi-type mixer are limited by the need of a pressure regulator to reduce the water pressure within the device (e.g., to less than 30 psi). Public water supplies typically use pressures between 30 psi to 130 psi, and the reduced pressure is necessary to protect internal components as well as to ensure that the pressure remains below the cracking pressure of the dispensing faucet, thereby preventing leaks, although pressure may still creep above the regulator set point and result in dripping from the faucet. A pressure regulator typically produces inconsistent flows, however, and provides an error range in the mixture of between 7-8%, which is of marginal quality. The accompanying reduced flow rate of the lower pressure also increases dispensing times.

By using a flow regulator, however, system 400 may provide a more consistent flow through venturi mixer 450 and achieve a better mixture error range (e.g., 4-5%), and possibly even approaching the optimal (i.e., 2.44%) without having to use a pump. Although the flow regulator may allow much higher pressures in the system (e.g., up to 140 psi), by proper design, the system may be able to handle the higher pressures. Using this arrangement eliminates the need for a pressure regulator in most cases, as water pressure available from public water supplies is normally much lower. Using a flow regulator also provides a higher flow rate, which provides better suction on the concentrate container and also allows for a faster dispensing rate.

Although FIG. 4 illustrates one example beverage dispensing system, other beverage dispensing systems may include fewer, additional, and/or a different arrangement of components. For example, a beverage dispensing system may include additional dispensing faucets. For instance, a beverage dispensing system may include two or three dispensing faucets. As another example, a beverage dispensing system may include a housing. The housing may, for example, include a beverage storage compartment and a beverage mix compartment. As another example, valve 440 may be located at other locations in system 400. For example, valve 440 could be located between venturi mixer 450 and dispensing faucet 460. In certain implementations, a switch (e.g., a button) may be used for activating valve 440 instead of dispensing faucet 460. The dispensing faucet may simply dispense the beverage without controlling fluid flow in these implementations. Additionally, a water supply may not be part of system 400.

Although the implementations have been illustrated with some detailed drawings, these should not be viewed as constraining the size and/or arrangements among components. In various implementations, different sizes and/or arrangements of components could be used while still achieving a beverage dispensing unit.

Several implementations have been disclosed, and many others have been mentioned or suggested. Additionally, those skilled in the art will recognize that a variety of additions, deletions, substitutions, and modifications may be made while still achieving beverage dispensing. Thus, the scope of the protected subject matter should be judged based on the following claims, which may encompass one or more features of one or more implementations.

1. A beverage dispensing system, comprising:
a flow controller adapted to regulate water flow rate therethrough;
a venturi-type mixer coupled to the flow controller and to a beverage concentrate syrup supply conduit, the mixer adapted to draw beverage concentrate syrup in response to water flowing through the mixer and begin mixing the beverage concentrate syrup with the water, the mixture of beverage concentrate syrup and water forming a beverage; and
a beverage dispensing faucet coupled to the mixer and adapted to receive the mixture and dispense the beverage.

2. The system of claim 1, wherein the mixer comprises a beverage concentrate syrup adjustment mechanism.

3. The system of claim 1, further comprising a water shut off coupled to the flow controller.

4. The system of claim 1, further comprising a water inlet coupled to the flow controller, the water inlet adapted to be connected to a public water supply.

5. The system of claim 1, further comprising a housing that surrounds the flow controller and the mixer.

6. The system of claim 5, wherein the beverage dispensing faucet is attached to the housing.

7. The system of claim 5, wherein the housing comprises a compartment for storing a container of beverage concentrate syrup above the mixer.

8. The system of claim 1, further comprising:
a second venturi-type mixer coupled to the flow controller and to a second beverage concentrate syrup supply conduit, the second mixer adapted to draw the second beverage concentrate syrup in response to water flowing through the second mixer and begin mixing the second beverage concentrate syrup with the water, the mixture of the second beverage concentrate syrup and water forming a second beverage; and
a second beverage dispensing faucet coupled to the second mixer and adapted to dispense the second beverage.

9. The system of claim 1, wherein:
the flow controller is adapted to allow a fluid pressure greater than 30 pounds per square inch (psi) downstream; and
the dispensing faucet is adapted to withstand fluid pressure greater than 30 psi.

10. The system of claim 9, wherein:
the flow controller is adapted to allow a fluid pressure greater than 70 psi downstream; and
the dispensing faucet is adapted to withstand fluid pressure greater than 70 psi.

11. The system of claim 1, wherein the mixer is adapted to substantially mix the beverage concentrate syrup and the water.

12. The system of claim 1, wherein the draw provided by the mixer regulates how much beverage concentrate syrup is mixed with the water.

13. The system of claim 1, wherein the beverage dispensing faucet comprises a handle and a nozzle, and activation of the handle manually controls how much fluid flows through the system.

14. A beverage dispensing system, comprising:
a flow controller adapted to regulate water flow rate therethrough;
a water inlet coupled to the flow controller, the water inlet adapted to be connected to a public water supply;
a venturi-type mixer coupled to the flow controller and to a beverage concentrate syrup supply conduit, the mixer adapted to draw beverage concentrate syrup in response to water flowing through the mixer and substantially mix the beverage concentrate syrup with the water, the draw provided by the mixer regulating how much beverage concentrate syrup is mixed with the water, the mixture of beverage concentrate syrup and water forming a beverage;
a housing that surrounds the flow controller and the mixer, the housing comprising a compartment for storing a container of beverage concentrate syrup above the mixer; and
a beverage dispensing faucet coupled to the mixer and adapted to receive the mixture and dispense the beverage, the beverage dispensing faucet attached to the housing and comprising a handle and a nozzle, wherein activation of the handle manually controls how much fluid flows through the system.
